(19) United States
(12) Patent Application Publication
(10) Pub. No.: US 2012/0034473 A1
(43) Pub. Date: Feb. 9, 2012

(54) METHOD FOR PRODUCING A CONNECTION OF GRAPHITE AND CARRIER METAL AND COMPOSITION ELEMENT

(75) Inventor: Hans-Christoph Mertins, Steinfurt (DE)

(73) Assignee: SGL CARBON SE, Wiesbaden (DE)

(21) Appl. No.: 13/247,040

(22) Filed: Sep. 28, 2011

Related U.S. Application Data
(63) Continuation of application No. PCT/EP2010/054129, filed on Mar. 29, 2010.

(30) Foreign Application Priority Data
Mar. 28, 2009 (DE) 10 2009 014 407.2

(51) Int. Cl. B32B 15/04; B32B 7/14; C09J 7/00

(52) U.S. Cl. 428/457; 156/306.6; 156/291

(57) ABSTRACT

A method produces a connection between a carrier metal layer and a graphite layer. Accordingly, the method includes providing a carrier metal layer; providing a graphite layer to be connected to the carrier metal layer; arranging a bonding layer having at least one metal between the carrier metal layer and the graphite layer; and connecting the carrier metal layer to the graphite layer. The connection includes a diffusion step wherein the metal is stimulated to penetrate at least partially into the graphite layer and/or the carrier metal layer, wherein the metal substantially remains in a solid phase.

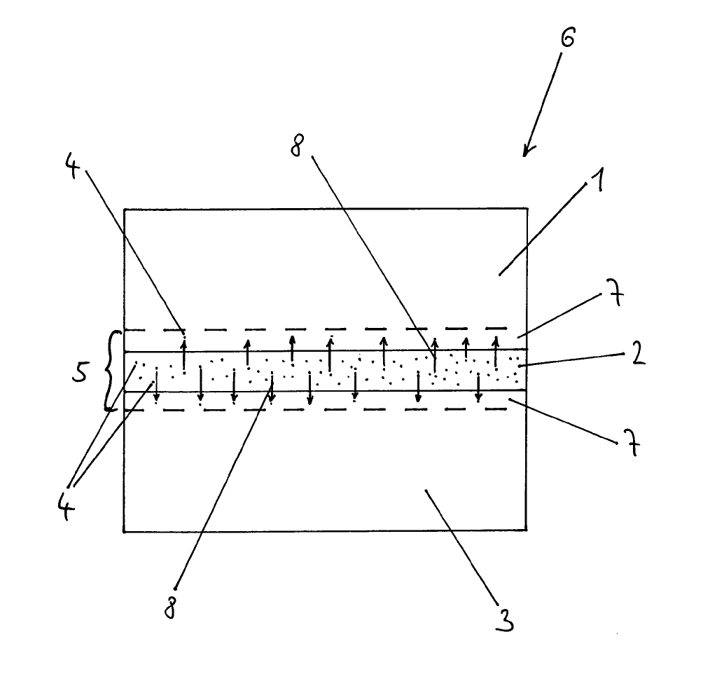

### CROSS-REFERENCE TO RELATED APPLICATION

This is a continuation application, under 35 U.S.C. §120, of copending international application No. PCT/EP2010/054129, filed Mar. 29, 2010, which designated the United States; this application also claims the priority, under 35 U.S.C. §119, of German patent application No. DE 10 2009 014 407.2, filed Mar. 28, 2009; the prior applications are herewith incorporated by reference in their entirety.

### BACKGROUND OF THE INVENTION

### Field of the Invention

The invention relates to a method for producing a connection between a carrier metal layer and a graphite layer, and also to a composite element containing a graphite layer and a carrier metal layer.

Graphite has good mechanical, thermal, electrical and chemical properties for many applications and is inexpensive and environmentally safe. Graphite is therefore used, for example, for lining containers in which high-temperature processes take place. Compared to plastics, graphite has the advantage of a chemically stable and neutral behavior toward processes, in particular even at relatively high temperatures. Owing to its malleable properties, graphite is used as sealing material in high-temperature and high-pressure installations. Since it is electrically conductive, graphite can be formed to give points or can be used as a cover for point electrodes in order to generate high electric fields. Similarly, graphite is used as a flat electrode in batteries.

Hereinbelow, the term “graphite” or “graphite layer” is intended to include any carbon-based substances or layers, for example shaped graphite bodies obtained by pressing expanded graphite, such as graphite foils, carbon layers with any amorphous or crystalline structure, carbon nanotubes or fullerenes, and carbon layers of any structure which have been produced by vapor deposition, sputtering or corresponding processes.

In order to improve the load-bearing capacity of graphite layers in terms of bending and tensile forces, to date these have been connected to a metal carrier on one or both sides. It is desirable that the mechanical, thermal, electrical and chemical properties of the graphite layer are not impaired by these connections. Apart from form-fitting connections, there are no known connections in the prior art in which these properties of the graphite can be retained after fixing to a metal carrier.

It is known to produce an adhesive bond between a graphite layer and a metal carrier by mechanical fixing and by adhesive bonding. The graphite layer can be mechanically fixed by interlocking with a metal carrier, this being produced by pressing with a reticular or rough carrier metal surface. In the case of an adhesive bond, the graphite layer is adhesively bonded to the carrier metal by organic or inorganic adhesives.

If a graphite layer is mechanically fixed to a metal carrier, this has the disadvantage that the graphite layer is damaged. Owing to the surface roughness, metal points which are present, for example, locally breach the graphite layer, and therefore the thermally insulating or the electrically conductive or else the sealing properties, for example, are impaired at these points. Furthermore, if the graphite is pressed onto the metal carrier, the graphite is compressed to such an extent that it can no longer be used as sealing material, for example. If microelectrodes or other small parts made of graphite are mechanically fixed by pressing, their shape changes when the force is exerted.

Adhesive bonds also have disadvantages. Here, the layer of adhesive between the metal carrier and the graphite layer typically has a thickness of at least several micrometers. This additional adhesive layer often does not satisfy the required chemical, thermal, electrical and mechanical conditions for the actual use of the graphite layer and thus restricts the scope of use of the adhesively bonded graphite. Particularly when used in a vacuum, the adhesive can degas and thereby contaminate the latter, or can collect on other components again and thus change their surface properties. At high temperatures, the adhesive can decompose, and the constituents thereof can pass into process gases or process liquids and thus influence the process operation. When the graphite layer is used as a pressure seal, the differing mechanical behavior of the adhesive and the graphite layer can lead to leakage problems. In addition, the contact pressure between the sealing flanges and thus the sealing action is reduced if the adhesive decomposes and dissolves. If the bond becomes soft or dissolves owing to an excessive temperature, the graphite layers can move or become detached entirely. In the case of individually fixed microelectrodes, the complete structure would thus be destroyed.

In some applications, it is necessary to ensure that there is an electrical contact between the metal carrier and the graphite layer, and therefore electrically conductive adhesives have to be used; this is associated with high costs.

In some methods, the layers coated with adhesive (the metal carrier and the graphite) have to be pressed together with very high pressures and at very high temperatures over a long time, for example over a plurality of hours. Owing to the accordingly complex design of the required presses, for example, this results in high production costs.

It is furthermore known to connect graphite and metal by vacuum soldering. This method has to be carried out under vacuum conditions and is therefore complex. In methods which combine vacuum soldering with a carbonization process, metal powders are scattered on and melted down at a very high temperature, and this makes these methods even more complex.

### SUMMARY OF THE INVENTION

It is accordingly an object of the invention to provide a method for producing a connection between a graphite and a carrier metal, and also a composite element which overcomes the above-mentioned disadvantages of the prior art methods and devices of this general type, wherein the connection is intended to be stronger than the inherent strength of the graphite under thermal and mechanical loading. This connection between graphite and carrier metal is intended to have a good electrical conductivity and thermal conductivity and should also be chemically stable. The elasto-plastic behavior thereof should be negligibly small compared to that of the graphite layer.

According to the method according to the invention, a connection is produced between a carrier metal layer and a graphite layer. A carrier metal layer is provided. A graphite layer to be connected to the carrier metal layer is provided and a bonding layer having at least one metal is arranged between the carrier metal layer and the graphite layer. The carrier metal layer is connected to the graphite layer, wherein the connection contains a diffusion step, in which the at least one metal of the bonding layer is stimulated to penetrate at least partially into the graphite layer and/or the carrier metal layer, wherein the metal remains substantially in a solid phase.

As a result, a connection with a high strength, a high electrical and thermal conductivity and a high chemical stability is obtained according to the invention without an adhesive bond, in the case of which an adhesive is required. The invention also manages without a mechanical connection, in the case of which the graphite layer is hooked in a rough or specially structured carrier metal surface by pressing, although such a mechanical connection may be present in addition to the connection made by the diffusion step according to the invention. In contrast to other connection methods, the metal here substantially does not melt, but rather remains in the solid phase. It is preferable for the metal to remain entirely in the solid phase throughout the method.

The term “graphite layers” contains thin self-supporting or applied films, foils or else thick plates or bodies of any desired shape or thickness. Alternatively, the term “shaped graphite body” could be used. The term relating to the layers is intended to explain that regions of graphite and of carrier metal close to the surface can be connected to one another. In particular, this can be a planar region intended for connection to another planar region. Within the context of the invention, a carrier metal layer could also be referred to as a shaped carrier metal body and have appropriate shapes and thicknesses.

It is preferable for the bonding layer to contain silver (Ag) as the metal or for the bonding layer to consist of Ag.

In this embodiment, the adhesive action is based on the penetration of Ag atoms from the bonding layer into the carrier metal layer and graphite layer which adjoin on both sides and are to be connected. In both materials, the metal atoms occupy lattice sites or interstitial lattice sites and preferably enter into bonds with the atoms there. The bonding of the Ag to graphite can be explained by the layered lattice structure of the graphite. Strong covalent a bonds based on the formation of sp² hybrid bonds act between the carbon atoms (C) within a layer plane of the graphite. In this case, the pₓ and p_{y} orbitals are oriented in trigonal form. The spacing between adjacent C atoms in the graphite planes is 0.142 nm. The third electron of the p, orbital points perpendicularly with respect to this layer plane and leads to a weak π bond based on Van der Waals forces. At 0.335 nm, the atom spacing between the planes is much greater than within the planes. It is presumed that Ag atoms with only one outer s electron readily accumulate on the electron of the p_{z} orbital and can therefore be strongly bonded. On the other hand, the relatively large spacing between the graphite planes allows for the Ag atoms to be incorporated, despite their large diameter of 0.306 nm, and leads to an improved connection between Ag atoms incorporated deep in the graphite layer and Ag atoms lying closer to a surface of the graphite layer, and this produces the stable bond between the bonding layer and the graphite. On the other hand, the relatively large lattice constant of 0.41 nm in Ag crystals also makes it possible for C atoms to be incorporated on interstitial lattice sites, which can contribute to the meshing of both layers. On account of this bonding process, even an Ag layer consisting of only a few atomic layers can preferably suffice for the production of a stable connection between the graphite and the carrier metal.

According to a preferred embodiment, the carrier metal layer contains at least one carrier metal or a carrier metal alloy selected from the group consisting of iron, steel, stainless steel, gold, palladium, titanium, copper, bronze, brass, chromium, nickel, zinc, tin, indium, manganese, aluminum, lead and cadmium or an alloy containing at least one of these metals or metal alloys thereof. Apart from lead and cadmium, all other known battery materials can be suitable for use in batteries.

The bonding of silver from the bonding layer to a stainless steel carrier is based presumably on the ability of Ag to be alloyed with chromium (Cr) and with nickel (Ni), but not on the bond with iron (Fe), with which it can be poorly alloyed. Since stainless steel has sufficient proportions of Cr and Ni, a bond of the Ag close to the surface of the stainless steel carrier is possible. The lattice spacings in stainless steel are in the region of 0.3 nm and therefore presumably make it possible for Ag atoms to also be incorporated at interstitial lattice sites. The same applies to the other preferred carrier metals and carrier metal alloys mentioned above. Here, the metals must not form the main constituent of an alloy, but rather can be present in the region of merely up to 10% by weight, in particular up to 5% by weight or even lower contents, for example 0.1 to 3% by weight.

As an alternative or in addition to the use of silver as the metal in the bonding layer, the metal is a metal with a similar behavior to silver in terms of its bonding behavior and/or diffusion behavior with respect to the carrier metal layer and/or graphite layer. Within the context of the invention, a similar behavior is understood to mean that the metal can diffuse into the graphite and/or carrier metal layer and at least partially enters into the bonding and incorporation conditions described further above for silver atoms, for example the electron bond. Examples of preferred metals or alloy constituents of the bonding layer may be gold (Au), copper (Cu), platinum (Pt), indium (In), chromium (Cr), molybdenum (Mo), silicon (Si), germanium (Ge), tin (Sn) and lead (Pb). Like Ag, Au and Cu have completely filled atomic shells and have only a single free outer electron on the s shell which can enter into a bond with the sp orbitals of the graphite. By way of example, the bonds Ag₂C₂ and Cu₂C₂ are known. Cr and Mo likewise have an outer s electron and filled or half-filled shells, and therefore these too have a behavior similar to silver. Si, Ge, Sn and Pb, as elements of the fourth group of the Periodic Table of the Elements, can enter into bonds with graphite by hybridization with the p electrons. These elements can partially substitute C atoms in the graphite plane as long as their atom diameter is not too large. Sulfur compounds, such as Ag₂S₂, can likewise enter into bonds. Sulfur often arises as an impurity, for example in carbon.

The diffusion step preferably contains a pressing step and/or a heating step. Under pressure and/or an elevated temperature, the at least one metal of the bonding layer is stimulated to diffuse into the graphite layer and/or the carrier metal layer. Here, the required pressure and/or the required temperature depend on the metal of the bonding layer and on the at least one carrier metal of the carrier metal layer.

It is advantageous that, before the diffusion step, the bonding layer has a thickness of between 1 nm and 100 nm, in particular between 2 and 80 nm, preferably between 5 and 50 nm. The smaller the layer thickness, the lesser the time and material required for providing the bonding layer, for example by coating. On account of the so-called law of associated shearing stresses, such thin layers react insensitively to shearing stresses. Shearing stresses are caused by transverse forces and occur in the case of bending loads, for example in the case of winding. In the connection plane, a bent sandwich structure is therefore subjected to a shearing stress which, figuratively speaking, attempts to push the connected layers one above another, which can lead to the bonding layer becoming detached. The thinner the bonding layer, the higher the mechanical resistance to detachment. A greater thickness, by contrast, advantageously makes it possible to provide a wider intermediate layer in the graphite layer and/or the carrier metal layer into which metal from the bonding layer has diffused, which can increase the mechanical strength of the connection produced.

The metal is preferably suitable for entering into a chemical bond with carbon. This can advantageously further enhance the connection between the graphite layer and the bonding layer.

According to a first alternative, before the diffusion step, the bonding layer has been or is applied to at least one of the two layers to be connected (the graphite layer, the carrier metal layer). This makes it possible, in particular, to provide a particularly thin bonding layer in the nanometer range.

It is preferable that the bonding layer has been or is applied to at least one of the two layers to be connected by a physical (PVD) and/or chemical vapor deposition (CVD) process. Such coating processes conventionally make it possible to apply homogeneous and high-quality layers even having a thickness of a few atomic layers up to several hundred nanometers. By way of example, CVD and PVD are thermal evaporation, sputtering processes, ion plating, cluster beam technology (ICBD). Through CVD and PVD processes, metal of the bonding layer is already connected intimately to elements of at least one of the two layers to be connected. As a result, a relatively low activation energy is needed to allow the metal to diffuse further in. Therefore, the connection mechanism of the present invention differs from a conventional soldering process or other conventional connection techniques.

Other known coating processes, such as electroplating, are also suitable as the coating process, in particular if thicker layers with a thickness in the micrometer range are desirable as the bonding layers. In contrast to known soldering processes, however, a liquid phase does not arise within the context of the invention even with relatively thick layers.

According to a second alternative, the bonding layer used is a self-supporting foil containing the metal, for example a metal foil. This bypasses a coating step, which may be advantageous, for example, if coating installations are not available.

A pressing duration of the pressing step is preferably up to 60 min, in particular between 5 and 50 min, in particular between 10 and 40 min. It can also be only 1 min, for example. Diffusion of the metal can thereby be brought about in a relatively short time. In order to subject the connection to the lowest possible thermal loading, a long pressing duration in combination with a low temperature can be advantageous. High temperatures make it possible for the pressing durations required to produce a stable connection to become shorter.

A heating temperature of the heating step is advantageously between one third of the melting point of the metal and below the melting point of the metal of the bonding layer. This avoids liquefaction of the bonding layer or of the metal in the bonding layer, but here the metal is stimulated so greatly that a diffusion step can take place. It is particularly preferable for a heating temperature to be between half the melting point in ° C. and 5 K below the melting point, in particular up to 20 K, in particular 50 K below the melting point.

Particularly if Ag is used as the metal in the bonding layer, a heating temperature above 300° C., in particular above 400° C., in particular above 500° C., is advantageous. If low-melting metals are used, an accordingly lower heating temperature may also be advantageous; if higher-melting metals are used, an accordingly higher heating temperature may also be advantageous. Owing to the susceptibility of graphite to temperatures starting from 550° C., in particular starting from 600° C., the method can advantageously be carried out under vacuum conditions.

It can be advantageous to apply the bonding layer to partial regions or to the whole area of the graphite layer and/or of the metal carrier layer. In particular, the bonding layer can be applied to the graphite layer and/or the carrier metal layer in structured form, for example pointwise or in certain portions. This can be advantageous, for example, for compensating for local stresses. An application to partial regions can also be advantageous so as not to close openings which are already present. This can be advantageous in the case of sieves or else diaphragms, for example for fuel cells.

Furthermore, the carrier metal layer can be present in structured form, for example in the form of islands or dots.

It can be advantageous that the carrier metal layer is applied to the bonding layer by a coating process.

Carrier metal layers can be structured particularly well, and applied in uniform thicknesses, by a coating process.

The carrier metal layer is preferably applied to the bonding layer by a physical and/or chemical vapor deposition process, in particular by a deposition process already described above for application of the bonding layer. Epitaxy processes can also be advantageous here, in particular. It is thereby advantageously possible to produce carrier metal layers with dimensions in the nanometer range or subnanometer range, but also thicker layers up to 1 μm. Such thick layers may be advantageous if very homogeneous layers, in particular with respect to the thickness, are desired. Such a thick layer may also be advantageous in terms of the homogeneity of an electrical conductivity in the direction of the layer plane.

The at least one graphite layer preferably contains a graphite foil, which includes at least partially compressed, expanded graphite. Graphite foil is particularly flexible and can advantageously also be connected to nonplanar carrier metal layers, without the composite element produced being subjected to mechanical stresses.

The pressing step advantageously contains a calendering step. Calendering can advantageously be used to avoid air inclusions between the individual layers and to also produce large-area connections. A continuous production process can also be carried out by calendaring. Other pressing methods which can also be advantageously carried out under vacuum conditions so as to avoid air inclusions can also be advantageous, however.

A composite element according to the invention contains a graphite layer and a carrier metal layer, which are connected by a bonding layer, in particular by a method according to the invention, wherein the bonding layer contains at least one metal which is stimulated by a diffusion step to penetrate at least partially into the graphite layer and/or the carrier metal layer.

The metal of the bonding layer has preferably diffused at least substantially completely into the graphite layer and/or carrier metal layer, such that the bonding layer is formed at least substantially exclusively by an intermediate layer, which consists of a mixture of the metal and the carrier metal and/or of the metal and the graphite.

The composite element is advantageously used for a sealing element. Good adhesion, high chemical resistance and thermal resistance are highly advantageous for a sealing element.

Other features which are considered as characteristic for the invention are set forth in the appended claims.

Although the invention is illustrated and described herein as embodied in a method for producing a connection of graphite and a carrier metal and a composite element, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

The single FIGURE of the drawing is a diagrammatic, cross-sectional view of a composite element according to the invention.

### DETAILED DESCRIPTION OF THE INVENTION

A stainless steel sheet as a carrier metal layer 1 is cleaned of grease, dust, etc. using a conventional method. A thin (10 nm) Ag layer is applied as a bonding layer 2 to the carrier metal layer 1 by PVD magnetron sputtering under appropriate vacuum conditions at room temperature. Then, a graphite foil is pressed as a graphite layer 3 onto that side of the carrier metal layer 1 provided with the Ag bonding layer under moderate temperature and pressure conditions. The graphite layer 3 is pressed on under air. A conventional, heatable pressing apparatus (not shown) is used for the pressing-on operation. The pressing-on and heating operations bring about a diffusion step, in which metal 4 from the bonding layer diffuses both into the graphite layer 3 and the stainless steel sheet 1, which is indicated by arrows 8 in the FIGURE. This produces a respective intermediate layer 7 in the region of the graphite layer 3 and of the carrier metal layer 1 adjoining the bonding layer 2, into which intermediate layer 7 metal from the bonding layer 2 has diffused.

A connection 5 or a composite element 6 is produced from a stainless steel foil which is coated on both sides with Ag, has a thickness of 50 μm and is positioned between two graphite layers having a thickness of 0.8 mm. With a heating temperature of 436° C., a contact pressure of 5.4×10⁶ Pa and a pressing duration of 10-30 minutes, mechanically stable connections and therefore composite elements are obtained. Detachment tests show that the adhesive bond is stronger than the inherent strength of the graphite. For optimization processes, it must be taken into account that, in terms of the depth of penetration of the metal into the layers, the time t only comes into play with √t, but the temperature comes into play exponentially. In further tests, the pressing duration has been gradually shortened, with a constant pressure of 5.4×10⁶ Pa and at a constant temperature of 436° C. Even in the case of pressing durations of only 5 minutes, it was still possible to obtain sufficient adhesion results. At a reduced pressure of 2.4×10⁶ Pa and at a heating temperature of 436° C., the minimum pressing duration for sufficient adhesion was 10 minutes.

The mechanical strength of the connections is determined using tearing tests. In the event of very good adhesion, the graphite layer tears intrinsically, whereas the carrier metal layer is covered completely by graphite adhering thereto. In the event of relatively poor adhesion, the carrier metal layer is covered with carbon to an extent of less than 100%. Further tests showed that there was very good adhesion of the connected layers even in the case of shearing forces greater than those mentioned above.

The method according to the invention has many advantages. The Ag bonding layer can be applied either to the graphite layer or, as in the above example, to the metal carrier. As a consequence of its small layer thickness, shrinkage, deformation or creeping of the bonding layer is ruled out. This is a major advantage compared to the behavior of typical adhesive layers, the layer thicknesses of which are between 0.2 μm and a plurality of micrometers and which are therefore 10 to 1000 times thicker than the preferred thickness of the bonding layer. Material can thus be saved to a considerable extent by the method according to the invention. Nevertheless, thicker bonding layers can also be used in a variant of the exemplary embodiment. In this variant, too, the graphite layer tears intrinsically when shearing forces are applied, and this proves that the graphite layer bonds very well to the carrier metal layer.

The graphite layer is pressed onto the carrier metal with considerably lower pressures compared to conventional methods. With the method according to the invention, it is therefore also possible to use machines which are designed to be less powerful. For the use as sealing material, this results in a further advantage, because the graphite layer itself is advantageously not solidified or is solidified only slightly and thus continues to retain its elasto-plastic deformation behavior.

In one variant of the exemplary embodiment, a layer of silver having a thickness of 25 nm is applied by high vacuum vapor deposition. In a further variant, a Cr layer 20 nm thick is applied before Ag is sputtered on. This layer can advantageously serve as an adhesion promoter for the subsequently applied bonding layer. In the case of unalloyed steel which itself does not comprise any chromium, chromium can serve particularly effectively as an adhesion promoter. The layer thickness can be set exactly in the nanometer range by all known CVD and PVD processes, but if desired also in the range of several 100 nm.

The Ag bonding layer is thermally stable almost up to the melting point of silver, which is 916° C. It is therefore far superior to the conventional adhesive bonds. The typical limit temperatures of the typical adhesive bonds are below 200° C. The graphite/carrier metal connected system according to the invention can therefore be used at considerably higher temperatures than has been the case to date, up to an upper limit of 450° C. This limit follows from the increased tendency of the graphite to oxidize at temperatures above 450° C. This upper limit is not impaired on account of the high melting temperature of Ag.

In contrast to conventional adhesives, the Ag bonding layer will not degas under vacuum conditions and therefore coat components or intervene in chemical processes.

Since silver is chemically very stable, the Ag bonding layer is far more chemically stable than the conventional adhesive bonds. Seals produced by the method according to the invention can therefore also be used in aggressive chemical processes, for example, which has not been possible to date.

Since Ag, as a metal, produces an electrically conductive adhesive bond, the graphite/metal carrier system as a whole is electrically conductive.

According to one variant, the composite element obtained according to the exemplary embodiment is used as a sealing element. Good adhesion, high chemical resistance and thermal resistance are highly advantageous for a sealing element. In particular, the seal has a multi-ply design, in which case it is preferable that two graphite layers form the outer two layers of a multi-ply structure.

The method for applying the bonding layer is relatively simple. It is also possible to coat large-area carrier metals using sputtering or vapor deposition techniques. This requires only a single operation, without aftertreatment. Preservation against oxygen or further processing under vacuum conditions is not required. The individual components can be temporarily stored for a relatively long time under air. It is also possible to press the graphite under atmospheric air. This does away with the need for an expensive vacuum processing installation, for example in the case of vacuum soldering processes. The method according to the invention can also be carried out with a considerably lower outlay compared to other conventional soldering processes or other processes in which, in particular, a liquid phase of a connecting metal arises.

At 5-30 minutes, the pressing duration of the graphite layer on the metal carrier in this method according to the invention is relatively short and therefore very economical compared to pressing durations in the range of hours for other bonding processes.

The invention is not restricted to the specifically described embodiments, but rather encompasses any possible combination of the features specified in the description, the examples and the claims, as long as these are technically meaningful.

In particular, the invention also encompasses pressures, temperatures and method durations which are not expressly mentioned but with which optimal connections can be produced with the respective metal of the bonding layer.

1. A method for producing a connection between a carrier metal layer and a graphite layer, which comprises the steps of:
providing the carrier metal layer;
providing the graphite layer to be connected to the carrier metal layer;
disposing a bonding layer having at least one metal between the carrier metal layer and the graphite layer; and
connecting the carrier metal layer to the graphite layer, wherein the connecting step includes a diffusion step, in which the metal of the bonding layer is stimulated to penetrate at least partially into at least one of the graphite layer or the carrier metal layer, wherein the metal remains substantially in a solid phase.

2. The method according to claim 1, which further comprises performing one of:
forming the bonding layer with silver; or
forming the metal from silver.

3. The method according to claim 1, which further comprise forming the carrier metal layer from a carrier metal selected from the group consisting of iron, steel, stainless steel, gold, palladium, titanium, copper, bronze, brass, chromium, nickel, zinc, tin, indium, manganese, aluminum, and an carrier metal alloy containing at least one of the above listed carrier metals.

4. The method according to claim 1, wherein the metal is a metal with a similar behavior to silver in terms of at least one of bonding behavior or diffusion behavior with respect to at least one of the carrier metal layer or the graphite layer.

5. The method according to claim 4, which further comprises selecting the at least one metal from the group consisting of gold, copper, platinum, indium, chromium, molybdenum, silicon, germanium, tin, lead and an alloy thereof.

6. The method according to claim 1, which further comprises performing the diffusion step with at least one of a pressing step or a heating step.

7. The method according to claim 1, wherein before the diffusion step is performed, forming the bonding layer to have a thickness of between 1 nm and 100 nm.

8. The method according to claim 1, wherein the at least one metal is suitable for entering into a chemical bond with carbon.

9. The method according to claim 1, wherein, before the diffusion step, the bonding layer has been applied to at least one of the carrier metal layer or the graphite layer.

10. The method according to claim 8, wherein after the bonding layer has been applied to at least one of the carrier metal layer or the graphite layer, the bonding layer is connected by at least one of a physical vapor deposition process or chemical vapor deposition process.

11. The method according to claim 1, which further comprising using a self-supporting foil having the metal as the bonding layer.

12. The method according to claim 6, wherein a pressing duration of the pressing step is up to 60 min.

13. The method according to claim 6, wherein a heating temperature of the heating step is between one third of a melting point of the metal and below the melting point of the metal of the bonding layer.

14. The method according to claim 13, which further comprises setting the temperature to be above 300° C.

15. The method according to claim 1, which further comprises applying the bonding layer to partial regions, including in structured form, or to a whole area of at least one of the graphite layer or of the metal carrier layer.

16. The method according to claim 1, wherein the carrier metal layer is present in structured form.

17. The method according to claim 1, which further comprises applying the carrier metal layer to the bonding layer by means of a coating process.

18. The method according to claimed in claim 17, which further comprises applying the carrier metal layer to the bonding layer by one of a physical vapor deposition process or chemical vapor deposition process.

19. The method according to claim 6, which further comprises performing a calendering step during the pressing step.

20. The method according to claim 1, which further comprises producing a composite element made of the at least one graphite layer and the least one carrier metal layer with an alternating sequence of the at least one carrier metal layer and the at least one graphite layer, wherein at least one of the graphite layer or the carrier metal layer is used as an outer layer of the composite element.

21. The method according to claim 1, wherein before the diffusion step is performed, forming the bonding layer to have a thickness of between 2 and 80 nm.

22. The method according to claim 1, wherein before the diffusion step is performed, forming the bonding layer to have a thickness of between 5 and 50 nm.

23. The method according to claim 1, which further comprising using a metal foil having the metal as the bonding layer.

24. The method according to claim 6, wherein a pressing duration of the pressing step is between 5 and 50 minutes.

25. The method according to claim 6, wherein a pressing duration of the pressing step is between 10 and 40 minutes.

26. The method according to claim 6, wherein a heating temperature of the heating step is between half of a melting point of the metal and 5 K below the melting point.

27. The method according to claim 13, which further comprises setting the temperature to be above 400° C.

28. The method according to claim 13, which further comprises setting the temperature to be above 500° C.

29. The method according to claim 1, wherein the carrier metal layer (1) is present in a form of islands or dots.

30. A composite element, comprising:
a bonding layer;
at least one graphite layer;
at least one carrier metal layer connected to said graphite layer by means of said bonding layer;
said bonding layer having at least one metal stimulated by a diffusion step to penetrate at least partially into at least one of said graphite layer or said carrier metal layer.

31. The composite element according to claim 30, wherein said metal of said bonding layer has diffused at least substantially completely into at least one of said graphite layer or said carrier metal layer, such that said bonding layer is formed at least substantially exclusively by an intermediate layer, which consists of a mixture of said metal and a carrier metal of said carrier metal layer or of said metal and said graphite layer.

32. The composite element according to 30, wherein said at least one graphite layer has a graphite foil, which contains at least partially compressed, expanded graphite.

33. The composite element according to 30, wherein said at least one carrier metal layer is connected to said graphite layered by means of said bonding layer by the method according to claim 1.

34. A sealing element, comprising:
a composite element, containing:
a bonding layer;
at least one graphite layer;
at least one carrier metal layer connected to said graphite layer by means of said bonding layer; and
said bonding layer having at least one metal stimulated by a diffusion step to penetrate at least partially into at least one of said graphite layer or said carrier metal layer.
